(19) United States
(12) Patent Application Publication
(10) Pub. No.: US 2011/0295772 A1
(43) Pub. Date: Dec. 1, 2011

(54) Systems and Methods for Developing and Optimizing Underutilized Real Property

(76) Inventor: Christopher Pawlik, Hawthorne, CA (US)

(21) Appl. No.: 13/118,348

(22) Filed: May 27, 2011

Related U.S. Application Data
(60) Provisional application No. 61/396,559, filed on May 28, 2010.

(51) Int. Cl. G06Q 90/00

(52) U.S. Cl. 705/500

(57) ABSTRACT

The present application is directed to methods for converting underutilized real property at existing land and improvements into energy producing property. An exemplary method comprises bifurcating energy production and management rights associated with the underutilized real property from the existing land and improvements.

### CROSS-REFERENCE TO RELATED APPLICATIONS

The present application claims the benefit of U.S. Provisional Application No. 61/396,559, filed on May 28, 2010, the entire disclosure of which is hereby incorporated herein by reference for all purposes.

### FIELD OF THE INVENTION

The present invention is directed to methods for converting underutilized real property into energy producing property.

### SUMMARY OF THE INVENTION

Various embodiments of the present invention include methods for converting underutilized real property at existing land and improvements into energy producing property. An exemplary method comprises bifurcating energy production and management rights associated with the underutilized real property from the existing land and improvements. Various embodiments of the methods may also include identifying the underutilized property, developing the identified underutilized property into energy producing property, integrating the developed property with the surrounding real estate or energy distribution grid, or managing the developed property to optimize returns.

### BRIEF DESCRIPTION OF THE DRAWINGS

FIG. 1 is a general flowchart of an exemplary method for converting underutilized real property into energy producing property according to various embodiments of the present invention.

FIG. 2 is a general flowchart of an exemplary method for converting underutilized real property into energy producing property according to various embodiments of the present invention.

FIGS. 3A and 3B are overhead views of commercial buildings illustrating potential underutilized real property on rooftops according to various embodiments of the present invention.

FIG. 3C is an overhead view of residential buildings illustrating potential underutilized real property on rooftops according to various embodiments of the present invention.

FIGS. 4A-4C are perspective views of commercial buildings illustrating potential underutilized real property on the exterior side surfaces of the buildings according to various embodiments of the present invention.

FIGS. 5A-5C are perspective views of commercial buildings illustrating potential underutilized real property on the façade of the buildings according to various embodiments of the present invention.

FIGS. 6A-6C are perspective views of commercial buildings illustrating potential underutilized real property appended to the building façade or attached to the buildings according to various embodiments of the present invention.

FIGS. 7A-7C are perspective views of interior spaces of commercial buildings illustrating potential underutilized real property within mechanical areas of the buildings according to various embodiments of the present invention.

FIGS. 8A and 8B are floor plans of commercial buildings illustrating potential underutilized real property in the building core according to various embodiments of the present invention.

FIGS. 9A and 9B are site plans for commercial properties illustrating potential underutilized real property in open land adjacent to buildings and parking lots according to various embodiments of the present invention.

FIGS. 10A and 10B are overhead views of parking lots and parking garages illustrating potential underutilized real property according to various embodiments of the present invention.

FIG. 11 is a schematic diagram illustrating exemplary energy sources and energy producing equipment according to various embodiments of the present invention.

### DETAILED DESCRIPTION

The present application is directed to methods for converting underutilized real property at existing land and improvements into energy producing property. An exemplary method comprises bifurcating energy production and management rights associated with the underutilized real property from the existing land and improvements. Various embodiments of the methods may also include identifying the underutilized property, developing the identified underutilized property into energy producing property, integrating the developed property with the surrounding real estate or energy distribution grid, or managing the developed property to optimize returns.

The real estate industry is comprised of four major asset categories, including industrial, retail, office, and residential (single and multi-family). There is also a wide variety of specialty-use categories such as health care, hospitality, flex, mixed-use, and sports and entertainment. These asset categories are general descriptions used to identify buildings by their typical use. Owners of these properties are in the business of leasing real estate space to companies or individuals for a specific period of time and a specific rental rate, relative to the tenant's risk profile and occupancy demand. Tenants typically identify a property to occupy based on the functions specific to their business, as well as the property's location, building specifications, and cost relative to comparable properties.

Commercial real estate values are driven by rental rates, occupancy rates, and available financing. To determine a basic value for a property, the annual effective income is determined, the annual operating expenses are subtracted, and a market-driven capitalization rate is applied to the net operating income. While each property is unique and the actual valuation of a property may be more complicated, a property owner's ability to manage these three major factors will directly impact the probability of achieving above-market returns.

It is typically in the best interest of the real estate owner to maximize property value in order to drive up selling price if the building were to be sold and to demand higher rental rates. General economic conditions significantly affect occupancy demand but the well-being of the economy, much like the capitalization rate, are beyond the control of the real estate owner. Therefore, operating expenses remain as the factor most in the control of the owner that directly affects the net income of the real property.

According to the U.S. EPA's Energy Star program, energy use is the single largest operating expense for commercial buildings and can represent as much as one-third of operating budgets and accounts for nearly 20 percent of the nation's annual greenhouse gas emissions. It is imperative, then, for the real estate owner to take all practical measures to reduce energy consumption to reduce operating costs. Even if the leases include a provision to pass through energy costs to the tenants, lower energy costs for a particular building will make space in that building more marketable. Many tenants are also cognizant of broader environmental concerns and demand more efficient energy usage.

While energy conservation measures can be designed into new building construction, owners of existing buildings, particularly older buildings or distressed properties, tend to focus on costs associated with items that do not require a capital outlay such as taxes, insurance, and maintenance for potential reductions.

There are a number of companies that provide high efficiency building equipment and energy auditing services for real estate owners. Updating building equipment and increasing operating efficiency are both methods of increasing property value that currently exist. However, most real estate owners fail to recognize that their properties contain underutilized space that may be converted into a distinct, specialized asset for the purpose of being developed into energy producing real estate.

In general, there are five types of rights (assets) for real estate: land ownership and improvements upon the land, mineral, billboard, cell tower, and air (although not recognized in the U.S.). Each of these rights conveys to the owner a tangible asset in the real estate that may be exploited. For example, the real estate owner may grant an easement to a billboard company or a cell phone company to erect a billboard or cell phone tower on the property, as well as allow access to the structure. Each of these rights is under the control of the real estate owner to the extent allowed by law and may be used to generate income from the property.

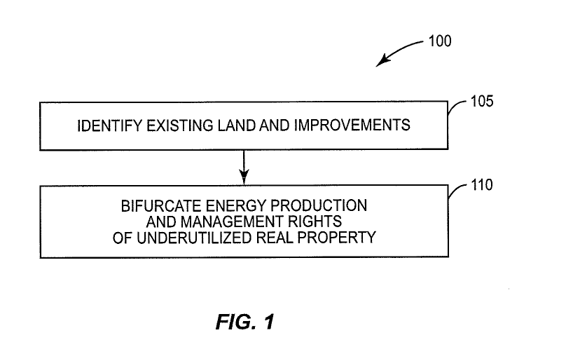

As mentioned above, most properties include underutilized space, such as rooftops, building facades, overhangs, parking lots, and unimproved land. The present invention addresses the need to increase income from the real estate and address the need to conserve scarce resources and move toward renewable energy sources by aligning the interests of the real estate, finance, and energy industries. FIG. 1 illustrates a general flow chart of various embodiments of a method 100 of the present invention to convert underutilized real property into energy producing property. At step 105, an existing land and improvements is identified. The energy production and management rights associated with underutilized real property on the existing land and improvements may then be bifurcated from the existing land and improvements (step 110). Thus, the method of FIG. 1 creates a new asset in the real property through the bifurcation of the energy production and management rights, which is distinct from the five rights in real estate described above.

The bifurcation may be accomplished through any of a variety of legal instruments, and may be carried out such that energy production and management rights run within the existing chain of title for the existing land and improvements. For example, all of the rights could be described in an easement that is on the existing chain of title. Alternately, a separate title could be created for the energy producing and management rights, along with an easement for access to the underutilized real property. Another option may be to include all of the easement information into the separate title. Each of these options is described in detail below. These options are exemplary and do not limit the scope of the present invention. Other legal instruments, combination of legal instruments, or legal procedures as are known in the art may be used to affect the bifurcation.

The various embodiments of the method of FIG. 1 may be carried out by performing any one or more of the following five steps:

1. Identifying underutilized real property;

2. Converting identified underutilized real property into a separate asset class;

3. Developing the identified underutilized real property into energy producing property;

4. Integrating the developed underutilized real property with the surrounding real estate or energy distribution grid; and

5. Managing the developed underutilized real property to optimize returns.

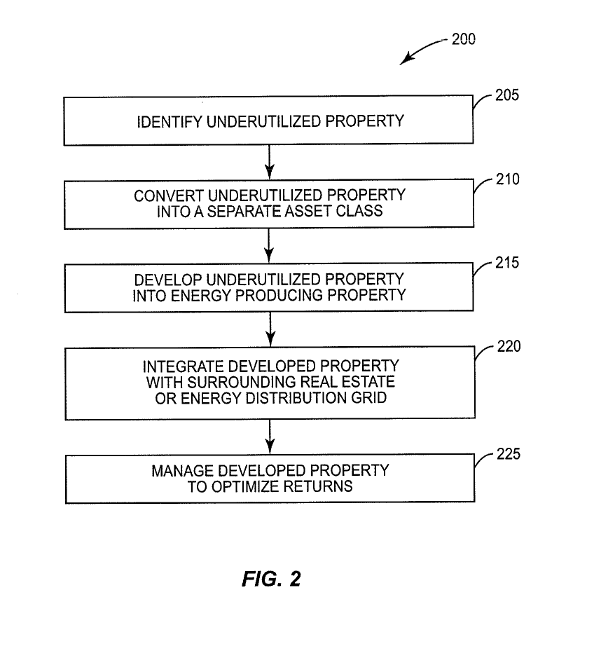

The five steps are illustrated in FIG. 2. While some of the embodiments of the method of FIG. 1 may involve all of the steps illustrated in method 200 of FIG. 2, other embodiments may require only a subset of these steps. Each step may be performed discretely, while other steps may overlap and be performed at least partially at the same time or in conjunction with one another. Each of the five steps is discussed in detail below.

### Identifying Underutilized Real Property

Beginning at step 205, the existing land and improvements may be examined to ascertain areas that are underutilized. In the context of the present invention, underutilized property means discrete areas of the real estate and improvements on the real estate that are not currently occupied with equipment, structural components of buildings, utility structures, vegetation that is undesirable or not possible to remove, or the like; are not required for access to equipment or structures; or are not the subject of a right of way or other easement or encumbrance. Underutilized property may also be generally accessible.

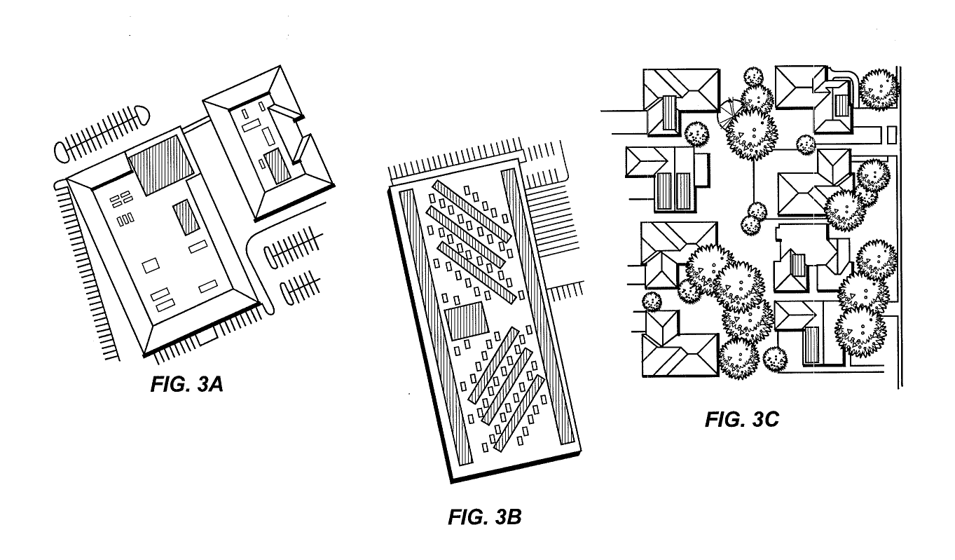

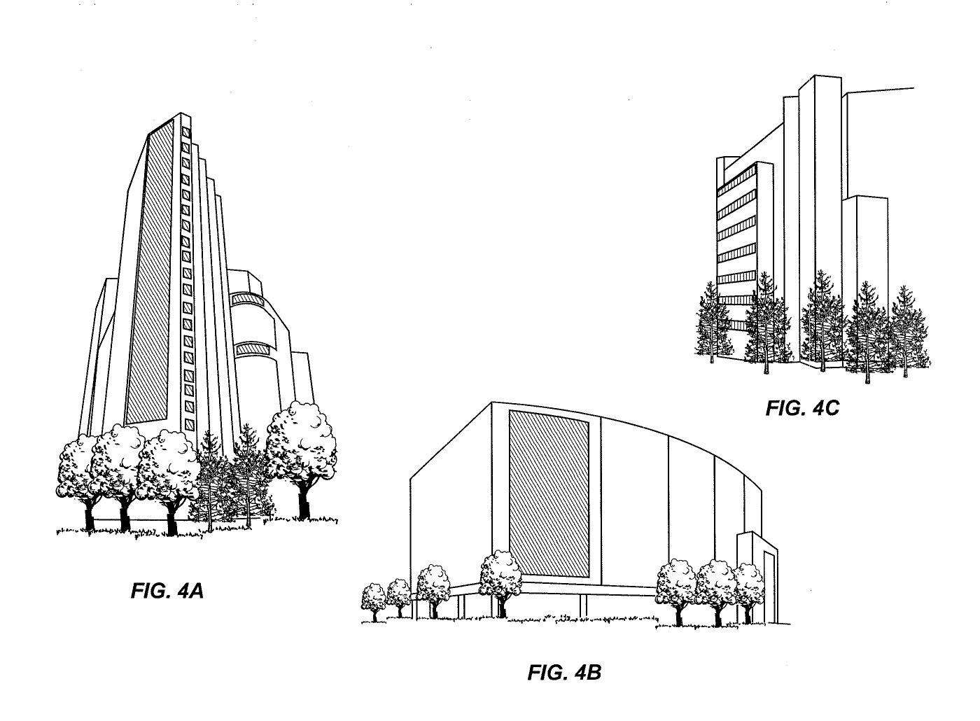

FIGS. 3-10 illustrate various examples of potential underutilized real property (depicted by the cross-hatched areas in each figure) for a variety of commercial and residential real property scenarios. FIGS. 3A and 3B illustrate underutilized real property on the exterior roofs of commercial buildings, while FIG. 3C illustrates the same on residential buildings. The areas designated as underutilized real property may exclude existing structures and equipment on the roofs such as air conditioner units, blowers, vents, stacks, chimneys, antennas, wiring, and the like, as well as areas needed to access the structures and equipment. Underutilized real property may not be limited to the tops of buildings. As illustrated in FIGS. 4A-4C, the exterior side surfaces of the buildings may be underutilized real property.

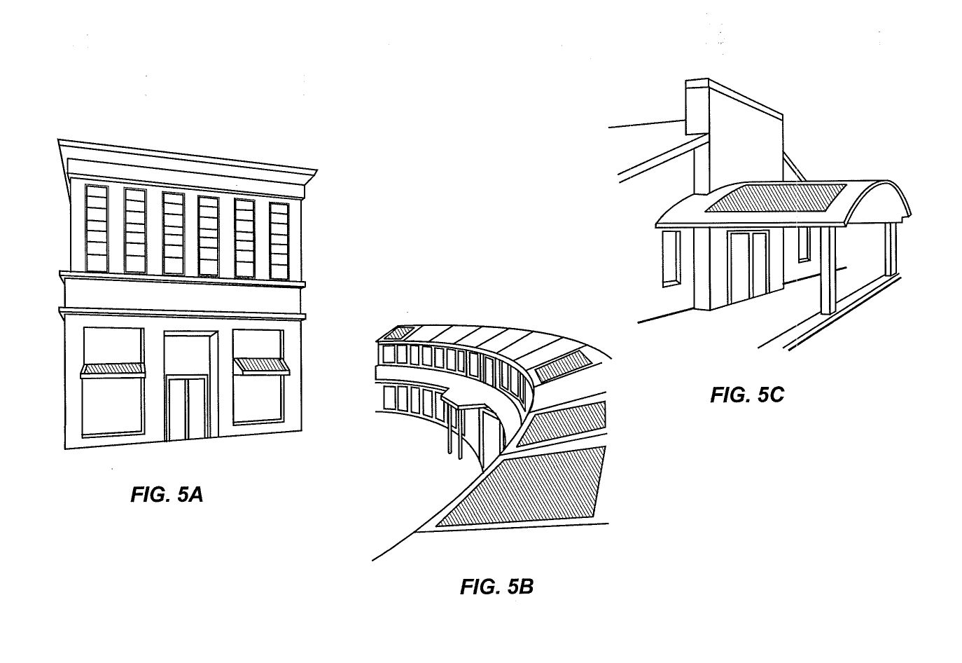

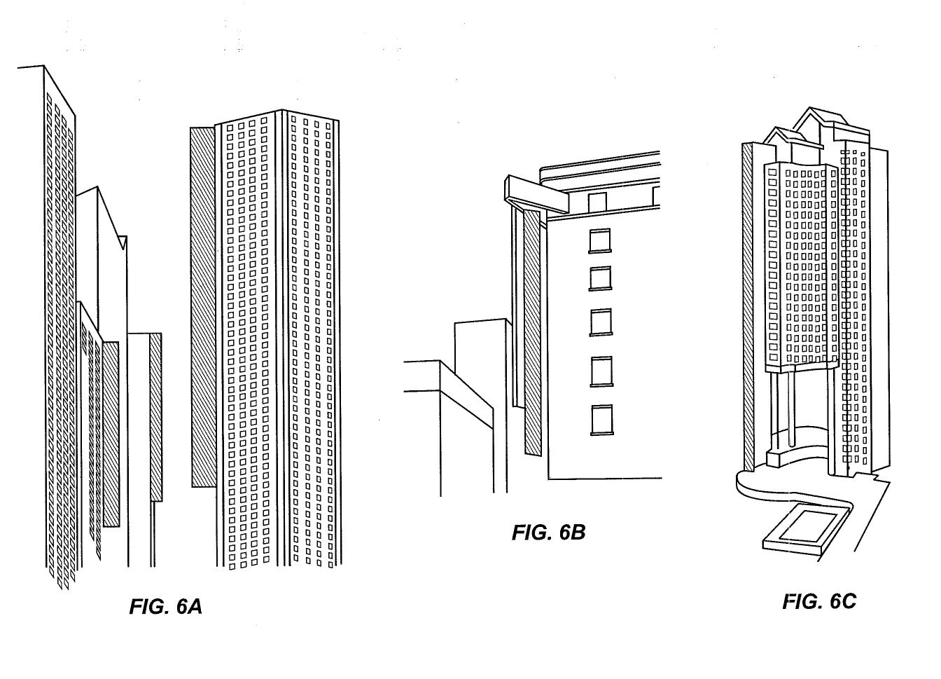

FIGS. 5A-5C show that various surfaces on the façade of buildings such as overhangs and awnings may be underutilized real property. Further, as illustrated in FIGS. 6A-6C, underutilized real property may be appended to the building façade or structures such as signs attached to the building.

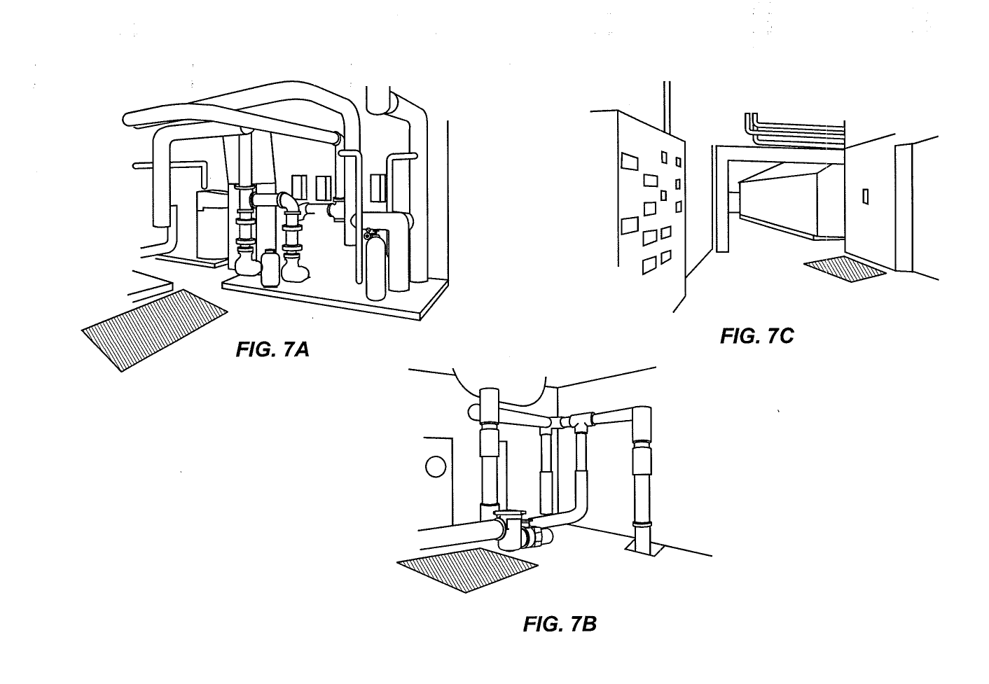

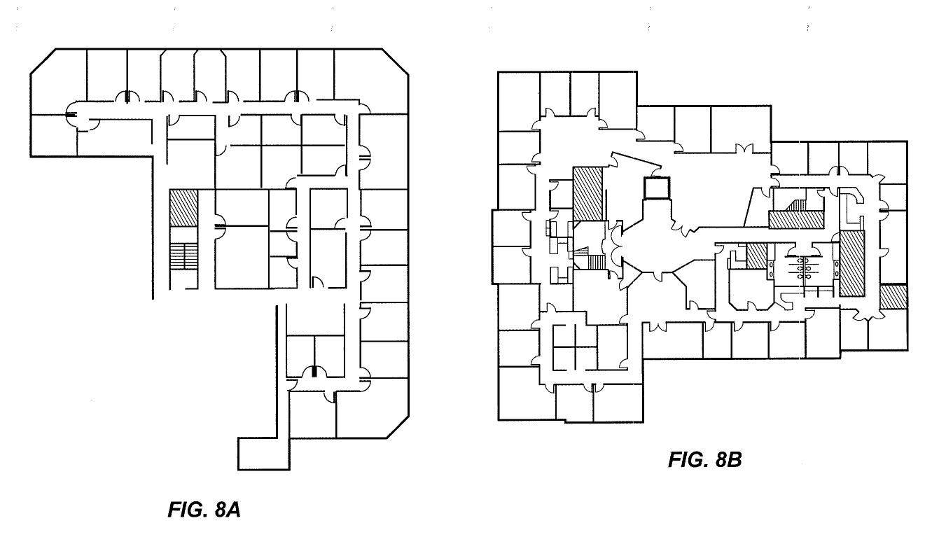

Underutilized real property may also be located on the interior of a building. FIGS. 7A-7C illustrate underutilized real property in mechanical areas of buildings that may be used to house equipment associated with energy generation, monitoring equipment, and control equipment. Other interior spaces may also include underutilized real property, such as the building core as shown in FIGS. 8A and 8B. The building core may include utility shafts, elevator shafts, stairwells, ventilation shafts, and the like.

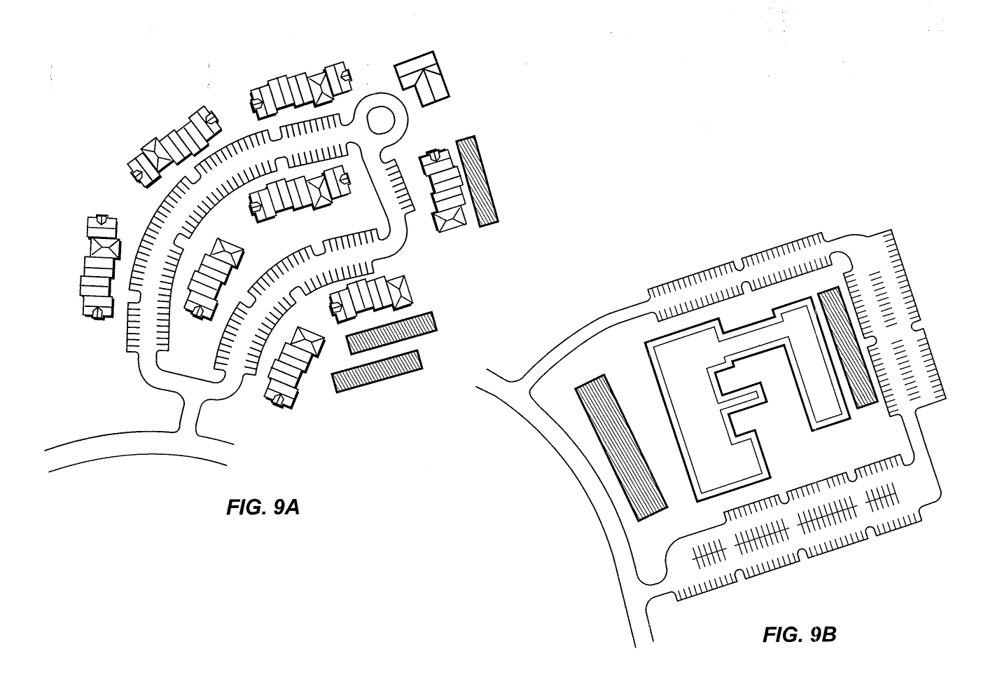

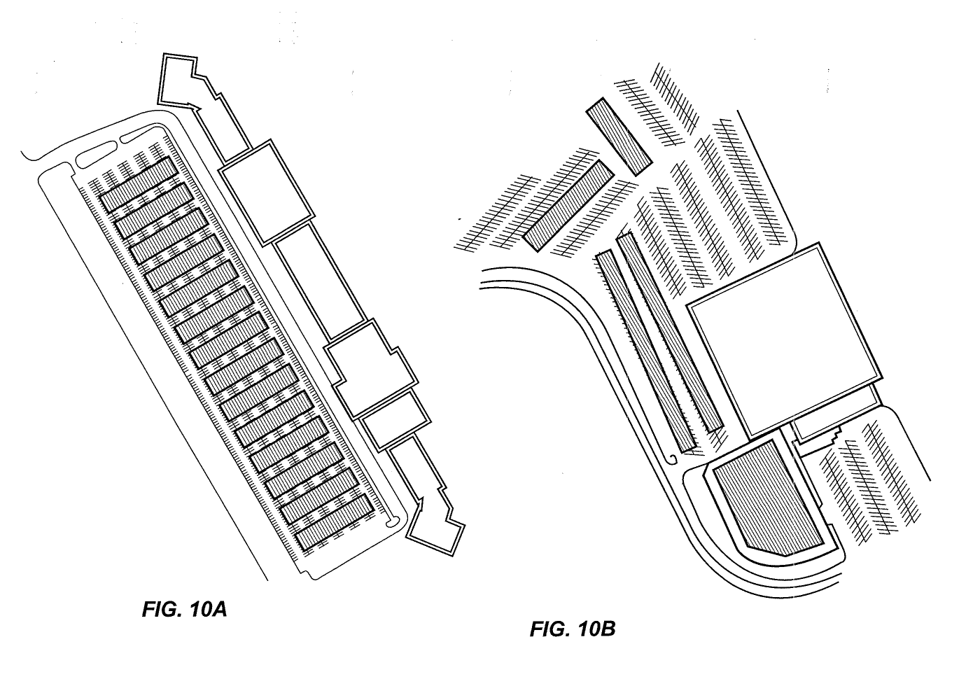

In addition to the areas on and within the building, the grounds surrounding the building may include underutilized real property. FIGS. 9A and 9B illustrate underutilized open land adjacent to buildings and parking lots. Similarly, areas in and around parking lots and garages may be underutilized real property as illustrated in FIGS. 10A and 10B.

Depending on the type of development contemplated for the energy producing property, a variety of issues may be analyzed to determine the feasibility of developing the identified space. For example, a development that includes solar panels may be most interested in the exterior surfaces of buildings and the grounds around the building. Further, southerly or southwesterly exposure with little or no obstruction of sunlight may be desirable. Additional equipment may be required to provide an interface between the solar panels and the existing electrical system within the building. Thus, some amount of underutilized interior space within the building may be required. In order to minimize installation costs, the interior space may preferably be located in proximity to the building's electrical system. Additionally, the solar panels and other equipment may require periodic maintenance and servicing, so the underutilized real property chosen should provide adequate access for personnel to perform these functions.

The real estate owner may also require access to existing building equipment, such as air conditioner units and electrical panels. The selection of underutilized real property should also take into account necessary access to existing building systems, structures, and utilities.

Identification of the underutilized real property may also include an analysis of the energy demands of the real estate and the solar resources available (assuming solar photovoltaic energy generation equipment will be used) at the identified underutilized real property. This type of analysis may be performed, at least in part, in conjunction with step 3, developing the identified underutilized real property into energy producing property. The overall building energy requirements in terms of kilowatt hours/day (kWh/day) may be determined from historical records or, as in the case of new construction, design estimates. The energy generating potential may then be calculated for a given type of equipment based on the solar insolation of the real estate, the surface area of solar panels that can be installed on the underutilized property, and the nominal power output of the solar panels. The energy generating capacity is then compared to the energy requirements of the real estate.

If the energy generating capacity exceeds the energy requirements, then the solar panels may provide the entire energy needs of the building or more. If the energy requirements exceed the generating capacity, then the energy generated may be dedicated to a specific energy load, such as interior lighting.

Other factors may also be considered when identifying the underutilized real property. Zoning requirements may restrict where solar panels or other energy generating equipment may be located. Zoning requirements may exclude some or all of the underutilized land area around the building from consideration. If the real estate includes older buildings, the zoning requirements may require that the older buildings be brought up to current code as part of the project. Such considerations may impact significantly on the financial viability of the project and should be addressed early in the planning stages.

Aesthetic concerns should also be addressed. The real estate owner or the tenants may not want the energy generating equipment to be highly visible, which would restrict which underutilized real property could be used. The owners of neighboring properties may also have aesthetic concerns.

The real estate owner should also be consulted on whether the underutilized real property is targeted for future development that would preclude placement of energy generating equipment. This would include rooftops as well as property surrounding the building. For example, an air conditioner unit or a heating, ventilating, and air conditioning (“HVAC”) unit on the roof may be targeted for replacement, and the new units may require a larger footprint or larger access area for installation.

### Converting Identified Underutilized Real Property into a Separate Asset Class

Because real estate owners are typically trying to maximize the income from their properties, they may be hesitant to accept a project that requires a capital outlay. Servicing the debt that may result from the capital outlay or losing the gains that could be achieved if that capital were instead invested may substantially affect overall profitability. Therefore, the real estate owner typically requires a quick return on investment in order to invest capital in the real estate and is more likely to pass on high energy costs to the tenant rather than purchase equipment to reduce energy consumption. Similarly, a residential homeowner remains in the home on average 3-7 years and has little interest in financing a project that has long-term implications. Both commercial and residential real estate owners may be hesitant to invest in technology today when that technology has a high probability of significantly evolving during the life of the technology. The owner does not want to be in a position of being tied into a particular technology then having that technology become obsolete before it is financially feasible to replace it.

The financial industry is more focused on large power generating projects such as a power plant rather than individual building systems because of the lower risk of dealing with a single entity instead of a diverse group of building owners. Also, the energy producing business is focused on producing energy in large amounts to supply a large grid network of users and has little inclination to explore single building systems.

In order to bring these three industries (real estate, finance, and energy) together to support an energy system for a single building, the present invention bifurcates the energy production and management rights from the existing land and improvements and forms a new class of real estate asset (step 210). As discussed previously, the bifurcation may be accomplished through a variety of legal mechanisms. One such mechanism is the creation of an easement. If the easement is used alone to bifurcate the energy production and management rights, then the easement may perform several functions. The first is to define and guarantee the energy production and management rights. These rights may include, for example, the right to install energy producing equipment within defined underutilized real property, to use the energy producing equipment to generate energy, to manage and upgrade the energy producing equipment, to interconnect with electrical wiring of the existing improvements, to allow ingress and egress to the underutilized real property, to sell the energy to the real estate owner and to other parties, and that these rights may in turn be conveyed to another party and may run with property or title.

The easement may also function to incorporate an energy purchase agreement between the owner of the existing land and improvements and a third party. The energy purchase agreement may specify, for example, how much energy may be produced in a given amount of time by the energy producing equipment, how much of that energy may be purchased by the owner of the existing land and improvements, the cost per unit of the energy (including any formulas for calculating the cost if not fixed, such as a percentage of the current commercial rate charged by the electric utility serving the property), when the energy purchase agreement expires, procedures for renewing the agreement, and how to arbitrate disputes concerning the energy purchase agreement.

In addition, the easement may also define the one or more underutilized real properties. For underutilized real properties located on or within a building, the easement may define the boundaries of the underutilized real property, such as a specific portion of the roof, as well as the height above the roof. Specifying the height of the underutilized real property may be of particular importance for interior areas of the building where clearance should be maintained for existing overhead equipment or utilities. The easement may also include provisions directing how the underutilized real property may be modified, such as increasing the underutilized real property subject to the easement in order to install additional energy producing equipment or controls.

The easement may be linked to the existing title of the land and improvements. The easement and existing title may be drafted such that the easement is on the existing chain of title and will move with that title. This may necessitate that the title be reissued to include the easement.

Another option for bifurcating the energy and production rights may be to issue both a new title for the energy and production rights and an easement. In this case, the new title may be deeded to an entity other than the title holder of the existing land and improvements and may describe the energy production and management rights, as well as the energy purchase agreement as described above. The easement may then function to define the underutilized real property and the ingress and egress rights as also described above. The easement may be linked to the new title, which may in turn be linked to the title of the existing land and improvements.

A still further option for bifurcating the energy production and management rights may be to issue only a new title in the energy production and management rights. The new title would essentially contain the same information as that described above for an easement issued without a title. The new title may be linked to the title of the existing land and improvements and move with the existing title.

Regardless of whether a title, an easement, or both or one or more other legal instruments are used to bifurcate the energy production and management rights, the mortgage holder for the existing land and improvements may have to subordinate any outstanding mortgage to the easement and exclude the energy production and management rights from the mortgage. Prior to the bifurcation of the energy production and management rights, the mortgage holder essentially assigned these rights zero value (the mortgage holder did not know these rights existed). Thus, even though the mortgage holder would be subordinating their rights to the energy production and management rights, the mortgage holder would be realizing a benefit because the value of the property may increase and the existing owner's debt service coverage ratio improves. Further, any financing of the development of the energy producing property would have no claim on the land and improvements, so the value of the outstanding mortgage on the land and improvements would not be negatively affected. The subordination may also serve to bind the holder of the title to the existing land and improvements to the new legal instrument and assure that the new title moves with the existing title. Linking the two titles (or other legal instruments) may also help to provide notice to others that the energy production and management rights have been bifurcated from the existing land and improvements without affecting the ownership of the actual land and improvements.

It may be necessary to reissue a title insurance policy to the owner of the land and improvements once the bifurcation and subordination is completed. A new title insurance policy may be issued to the owner of the energy production rights.

The bifurcation and subordination will not likely affect the mortgage holder's interest in the land and improvements. In fact, bifurcating the energy production and management rights may improve the overall value of the property. The present invention may decrease the cost of operating the property and increase the “green” image of the property, both of which may serve to increase marketability. Lower operating costs for tenants also help assure that the tenants may be in a better financial position and may be more likely to pay rent consistently. If the mortgage holder were ever to foreclose on the property, the property may have the added benefit of energy producing equipment already installed and operational.

The new title, easement, or other legal instrument may be owned by an entity other than the owner of the existing land and improvements. This third party entity may be a management company that brings together owners of existing land and improvements and suppliers/manufacturers of energy producing equipment. The third party may be the suppliers/manufacturers of energy producing equipment. The third party may be actively involved in the operation and management of the energy producing equipment, or may contract out that function to another entity (in some cases, the supplier/manufacturer of energy producing equipment). The ownership in the new title, easement, or other legal instrument may be held individually, jointly, in common, or in corporate or partnership form.

The bifurcation of the energy production and management rights may also require the approval of various government agencies for zoning and building codes. In addition, approval of homeowners associations or other ownership associations may be required to assure that covenants are followed.

### Developing the Identified Underutilized Real Property into Energy Producing Property

Returning to FIG. 2, step 215 is the physical development of the underutilized real property into energy producing property. This step may also include the financial development of the project. A development plan may be developed which addresses details associated with the design and layout of the energy producing equipment, controls, monitoring systems, and wiring; functionality of the energy producing equipment; and construction logistics specific to the identified underutilized real property. The development plan may take into account a broad range of factors including, but not limited to, building age, current layout of rooftop and interior equipment, solar obstructions, rooftop load capacity, roof membrane age and type, the building's energy management system, and local climatological conditions.

The development plan may focus on how to minimize the effect of the development on the existing structure and building envelope, and to minimize the effect on current tenants. The ongoing maintenance requirements of existing building systems should be taken into account when deciding on placement of equipment and interconnection with existing wiring. Maintenance of the existing roof membrane should also be considered, in particular how roof repairs and replacement may be carried out once the energy producing equipment is installed. An access interconnection agreement between an occupant, owner, or tenant and a third party may be developed as part of the development plan (or separately). The access interconnection agreement may specify details concerning how and when interconnection with existing building electrical wiring will occur.

Another aspect of the development step is the proper sizing of the energy producing equipment. This may involve an in-depth analysis of current building energy requirements, including how the energy is used in the building. For example, the air conditioning system or HVAC system may account for a significant amount of the overall energy demand, but electricity for these systems may be supplied as alternating current rated at 220 volts. Depending on the energy producing equipment selected, it may not be feasible to supply electricity at this rating. It may be more efficient to supply loads that draw lower voltage and/or amperage. It may also be more efficient to supply loads that use direct current rather than alternating current. For example, if the energy producing equipment is comprised of solar panels, then direct current is generated. If the electricity from the solar panels is used to power alternating current sources, then the direct current must be converted to alternating current, which may introduce significant inefficiencies. In this example, it may be possible to run the fluorescent lights in the building directly from the current produced by the solar panels

Another type of analysis that may be performed in the equipment selection process is determining an amount of energy that may be generated per unit area of space occupied by the energy generating equipment. For example, if 500 square feet of roof space is available for installation of solar panels and the energy load to be supplied is 60,000 kWh, then the energy generating equipment will be required to generate at least about 120 kWh per square foot of installation space. A similar analysis may be performed for a volume of space (cubic feet) occupied by the energy generating equipment, particularly equipment that is installed inside the building.

When deciding how much energy producing equipment should be purchased, consideration may be given to whether it is more desirable to size the system so that it is slightly under the load such that all of the energy generated may be sold according to the energy purchase agreement, or more desirable to generate an excess (or at least have the ability to generate an excess) that may be sold to a neighboring property or the electric grid. If it is sold to a neighboring property, then a bifurcation of the energy production and management rights may also be performed for that property.

Excess generated energy may also be stored rather than sold to another user. In this case, the equipment selection process may consider energy storage equipment such as batteries and capacitors. Since energy storage equipment may require a significant amount of physical space, careful planning may be needed to place adequate storage in limited available areas.

Development of financing may also be included in this step. Given that the energy production and management rights will be bifurcated from the existing land and improvements as a separate asset, any financing required for equipment purchase and installation may be established under real estate lending models rather than capital expenditures. Real estate financing may provide more favorable loan terms due to the essentially guaranteed income by the energy purchase agreement or access interconnection agreement. The energy generating equipment itself may also be used for collateral.

Another component of the financial development may be obtaining business interruption insurance. A number of factors, such as vandalism, natural disasters, accidents, weather damage, and the like may impair the performance of the energy producing equipment, or stop performance entirely. The business interruption insurance may be used to maintain cash flow until repairs can be made.

### Integrating the Developed Underutilized Real Property with the Surrounding Real Estate or Energy Distribution Grid

Integrating the developed underutilized real property with surrounding property or the electric grid may be accomplished at step 220 of FIG. 2. Integration may be used where, as described above, excess energy is produced by the energy generating equipment. Where the excess energy is sold to a nearby building, then physical interconnection with the utility systems of the nearby building may be required. At least a portion of the integration step may be performed under the development step (step 215).

Integration with surrounding real estate carries with it certain inherent risks which require risk management planning. If a fire occurs at a building on the surrounding property after integration with that building's electrical system, or a person is injured by coming into contact with the integrated system, the cause may be attributed to the integrated system. This may subject the title holder of the bifurcated energy production and management rights to liability for the damage. Therefore, the integration step may involve an analysis of this risk and the purchase of adequate insurance coverage.

Before lenders agree to underwrite project costs and before insurance carriers will issue policies, these entities may require confirmation that contractors and subcontractors involved with the project are licensed professionals with adequate experience with the types of systems involved. Proper experience may be particularly relevant for work involving integration with the electrical systems of other buildings or the electric grid.

Integration with other buildings or the electric grid may depend on their location relative to the underutilized real property. Excessive interconnection distance may increase initial capital costs beyond the threshold that provides adequate investor returns. Maintenance costs are likely to rise as the interconnection distances increase, which may threaten overall profitability. Additionally, longer cables required to cover long interconnection distances may lead to transmission losses and reduce the amount of saleable energy.

In the examples provided above, direct current produced by solar panels may be used to power fluorescent lighting. Because any existing lighting systems are wired into the alternating current system, the interconnection process may have to take into account the revised wiring to disconnect from the alternating current system and connect with the direct current system.

### Managing the Developed Underutilized Real Property to Optimize Returns

Management of the developed underutilized real property (step 225) may be performed by the title holder of the energy production and management rights, or at least a portion of the management functions may be contracted to another entity. Regardless of who carries out the management function, managing the developed property will involve performing required maintenance and upkeep, as well as monitoring the energy producing equipment and adjusting the equipment to maintain optimal operating conditions.

System upkeep and maintenance may include keeping solar panels free of obstructions, keeping any combustion equipment operating efficiently including maintaining uninterrupted fuel supplies, and maintaining adequate access to energy generating equipment. A primary purpose of the management function may be to maintain a consistently running system that is transparent to the energy user.

In addition to day-to-day management and operation of the energy generating equipment, the management function includes long-term planning. Development of neighboring properties should be monitored to ascertain whether the development will affect the energy generating equipment. For example, a tall building erected next to a solar panel array may block direct sunlight exposure. In some cases, it may be necessary to seek a negative easement for the owner of adjacent properties, although such easements may prove to be prohibitively expensive. Changes in zoning ordinances may also affect what can be built on neighboring property, so the management function may include following and reacting to proposed zoning changes.

The above description of the present invention includes discussions of energy producing equipment. While solar panels (photovoltaic systems) have been used as a convenient example throughout the discussions, other energy producing systems as are known in the art may also be used. Examples of energy producing equipment other than solar panels include biodiesel combustion, natural gas combustion, fuel cells, windmills, wind turbines, anaerobic digester systems, and nuclear generators. Other energy producing equipment such as coal and petroleum combustion equipment may also be considered for the present invention, although cleaner energy sources may be preferred. In addition, the bifurcated energy production and management rights as discussed above generally encompass all forms of energy production. However, the legal instrument granting the rights may be limited to one or more form of energy production.

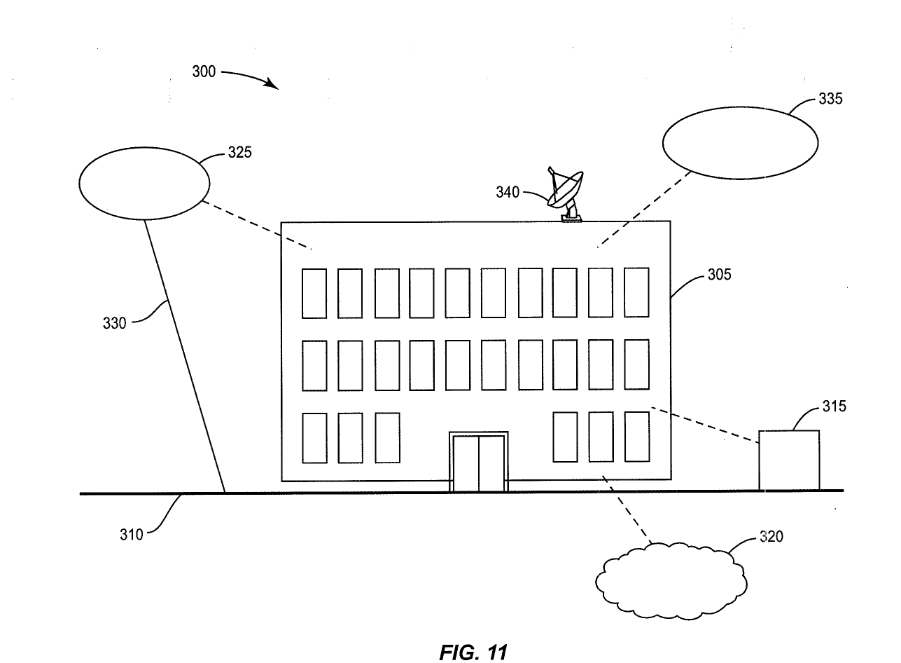

Additionally, the discussion of the energy producing equipment places the equipment either on the land (e.g., solar panel located on the land surrounding the building), on the improvement (e.g., solar panel located on the building roof), or in the improvement (e.g., fuel cell located within the building). The scope of the present invention includes energy producing equipment wherever located in relation to the land and improvement, or energy sources wherever located in relation to the land and improvements. FIG. 11 illustrates a system 300 comprised of land and improvements and energy producing equipment and energy sources (referred to herein as energy source/equipment). Improvement (building) 305 is located on land 310. In addition to the energy producing equipment discussed previously, other energy sources/equipment 315 may be located apart from land 310, such as a hydroelectric dam located some distance from land 310. An underground energy source/equipment 320, such as a geothermal energy source, may be located below a surface of the land 310 yet provide energy to the improvement 305. Likewise, a suspended energy source/equipment 325 may be positioned in the space above the land 310 (or apart from land 310) and may be held in place by tether 330 or other means of fixing the suspended energy source/equipment. For example, a wind turbine could be suspended high enough in the atmosphere to encounter more continuous winds than may be encountered near the surface of land 310. Solar reflectors could also be suspended above the land 310. Finally, an airborne energy source/equipment 335 may be in the atmosphere, or above the atmosphere, such as a laser in orbit around the earth. The airborne energy source/equipment 335 may utilize wireless transmission of energy which may be received at the land and improvements by a receiver such as satellite antenna 340. The dashed lines in FIG. 11 represent transmission of energy (whether wired, wireless, or other technology) from the energy source equipment 315, 320, 325, 335 by any means know in the art or that may become known in the art. The energy sources/equipment 315, 320, 325, 335 comprise energy sources and energy producing equipment known in the art or that may become known in the art.

An exemplary computing system may be used to implement various embodiments of the systems and methods disclosed herein. The computing system may include one or more processors and memory. Main memory stores, in part, instructions and data for execution by a processor to cause the computing system to control the operation of the various elements in the systems described herein to provide the functionality of certain embodiments. Main memory may include a number of memories including a main random access memory (RAM) for storage of instructions and data during program execution and a read only memory (ROM) in which fixed instructions are stored. Main memory may store executable code when in operation. The system further may include a mass storage device, portable storage medium drive(s), output devices, user input devices, a graphics display, and peripheral devices. The components may be connected via a single bus. Alternatively, the components may be connected via multiple buses. The components may be connected through one or more data transport means. Processor unit and main memory may be connected via a local microprocessor bus, and the mass storage device, peripheral device(s), portable storage device, and display system may be connected via one or more input/output (I/O) buses. Mass storage device, which may be implemented with a magnetic disk drive or an optical disk drive, may be a non-volatile storage device for storing data and instructions for use by the processor unit. Mass storage device may store the system software for implementing various embodiments of the disclosed systems and methods for purposes of loading that software into the main memory. Portable storage devices may operate in conjunction with a portable non-volatile storage medium, such as a floppy disk, compact disk or Digital video disc, to input and output data and code to and from the computing system. The system software for implementing various embodiments of the systems and methods disclosed herein may be stored on such a portable medium and input to the computing system via the portable storage device. Input devices may provide a portion of a user interface. Input devices may include an alpha-numeric keypad, such as a keyboard, for inputting alpha-numeric and other information, or a pointing device, such as a mouse, a trackball, stylus, or cursor direction keys. In general, the term input device is intended to include all possible types of devices and ways to input information into the computing system. Additionally, the system may include output devices. Suitable output devices include speakers, printers, network interfaces, and monitors. Display system may include a liquid crystal display (LCD) or other suitable display device.

Display system may receive textual and graphical information, and processes the information for output to the display device. In general, use of the term output device is intended to include all possible types of devices and ways to output information from the computing system to the user or to another machine or computing system. Peripherals may include any type of computer support device to add additional functionality to the computing system. Peripheral device(s) may include a modem or a router or other type of component to provide an interface to a communication network. The communication network may comprise many interconnected computing systems and communication links. The communication links may be wireline links, optical links, wireless links, or any other mechanisms for communication of information. The components contained in the computing system may be those typically found in computing systems that may be suitable for use with embodiments of the systems and methods disclosed herein and are intended to represent a broad category of such computing components that are well known in the art. Thus, the computing system may be a personal computer, hand held computing device, telephone, mobile computing device, workstation, server, minicomputer, mainframe computer, or any other computing device. The computer may also include different bus configurations, networked platforms, multi-processor platforms, etc.

Various operating systems may be used including Unix, Linux, Windows, Macintosh OS, Palm OS, MS-DOS, MINIX, VMS, OS/2, and other suitable operating systems. Due to the ever changing nature of computers and networks, the description of the computing system is intended only as a specific example for purposes of describing embodiments. Many other configurations of the computing system are possible having more or less components.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

### Example

A feasibility study of the methods of the present invention was completed for the Summit State Bank building in Santa Rosa, Calif. The building is located at 500 Bicentennial Way near Highway 101. The building was constructed in 2002 and houses a number of tenants. The feasibility study completed many of five steps of various embodiments of the present invention as described below. One of the steps not completed was drawing up the legal instruments for bifurcating the energy production and management rights. As this was a feasibility study centering on an economic outcome, it was not necessary to complete the legal instruments necessary to affect the bifurcation.

Santa Rosa has cool, wet winters and warm, mostly dry summers. In the summer, nights are usually foggy but the fog generally clears to sunny weather in the late morning to midday. The average annual rainfall is 30.45 inches, with 265 days of sunny weather. The daily temperature ranges from an average low of 44.7° F. to an average high of 71.7° F.

The average solar insolation over a full year is 4.48 kWhr/day. Over the course of the year, the monthly insolation peaks in the summer months and gradually decreases through the winter months, reaching its lowest point in the December-January timeframe. The insolation information was used to determine the generation potential of all solar power options investigated.

An analysis of the electricity demand of the Summit State Bank building was performed to ensure that there was sufficient demand within the building for electricity generated by a rooftop solar panel installation. Information gathered during a site visit to the bank building, coupled with information collected from the building's main electricity provider, Pacific Gas and Electric (PG&E), provided the basis for the demand analysis.

The building is comprised of three stories of office space. The main energy consuming units in the building are indoor and outdoor lighting, office equipment (photocopiers, computers, and telephones), and the air conditioning system.

The electricity usage of the building is tracked by a total of six meters. PG&E provided the electricity and billing information from March 2010 to February 2011. This information was analyzed in detail to generate an annual electricity consumption model for the building.

The annual electricity consumption for the building was plotted and tabulated. The electricity consumption of the building was categorized into “on peak,” “partial peak,” and “off peak” corresponding to the time at which the electricity was consumed. Each category was billed at a different rate.

The building consumed about 593,000 kWhr annually at a total cost of $100,000, bringing the average cost of electricity per kWhr to $0.169. The electricity charge varies seasonally. Total electricity charges for the months of May to October are about 30 percent more expensive than the other months primarily due to increased consumption of “on peak” electricity which is billed at a higher rate.

The Summit State Bank building has ample rooftop space available for a solar installation. The overall footprint of the rooftop measures 88 feet×120 feet. In the center of the rooftop, however, is an elliptical enclosure that houses the building's HVAC system components. The remaining area is available for solar panels. In calculating the total amount of area available for solar panels, it was prudent to leave space adjacent to the walls of the roof open to avoid shading. The resulting area available for the solar installation was estimated to be 394 square meters.

The photovoltaic (PV) system included a number of components in addition to the solar panel modules themselves. The following paragraphs discuss the racking system for mounting the panels, the power management system for directing the generated electricity, and the wiring for delivering the electricity.

First, a racking and mounting system was necessary to keep the modules in place during normal operation and in times of inclement weather. Unfortunately, the weatherproofing on the rooftop of the Summit State Bank building precluded the ability to drill holes into the roof because holes would compromise the seals on the roof. Consequently, a mounting system was used consisting of a weighted ballast that will keep the system grounded regardless of the wind speed.

Several different racking systems are described below. All of the racking systems described have both flush mount and tilt mount options. In flush mounting, the solar panels are mounted parallel to the roof, creating a visually aesthetic appearance. In tilt mounting, the solar panels are mounted at the optimal angle to maximize solar power generation, which is usually adjusted seasonally.

Unirac SolarMount™

The Unirac racking system consisted of a rail set and clip set matched to the type and quantity of panels to mount the panels flush with a roof. The racking system is available in three options: SolarMount Light, Standard, and Heavy Duty. The pricing may reach a minimum of $0.10/W.

Silverback Solar™

The Silverback Solar racking system created a structural mounting that attached directly to the roof framing, thus enabling solar panel mounting without jeopardizing the roof lifespan or integrity.

ProSolar RoofTrac™

The ProSolar racking system was an aluminum and stainless steel racking system that was priced as low as $0.10/W. The racking system was tested to withstand winds up to 125 mph to ensure safety and quality. The racking system attached to the roof via the ProSolar TileTrac™ system, which screwed into the roof tiles.

AEE Solar SnapNrack™

The AEE system was a new line of solar racking system from AEE Solar specifically designed to reduce installation time, thus reducing installation labor costs. The entire design utilized the same size bolts and is compatible with the majority of commercial PV modules. The price of the mount system was approximately $0.25/W.

The Nextek Power Management system was investigated for its potential to increase the efficiency of utilization of the solar power generated by the recommended PV solution. Typical solar energy installations utilize an inverter to convert the DC current generated by the solar panels to an AC current for compatibility with the electricity delivered by the grid. Unfortunately, about 20 percent of the energy is lost when converting from DC to AC in a typical inverter. Some of the AC current is then typically converted back to DC for powering lighting ballasts.

The Nextek system replaced the DC to AC power inverter necessary for most solar installation with a DC network capable of directly powering the DC lighting loads as well as other DC loads. It was shown by the System Advisor Model (SAM) analysis that the inverter represents a significant source of efficiency reductions for the system, so the Nextek system could increase the annual energy delivered by the system with minimal increases in cost. In fact, the installation costs of the Nextek system were reported to be about the same as the inverter cost on a per Watt basis.

When the solar panels were not generating electricity, the Nextek system converted AC power from the grid to the lighting load so that the load was always served. The primary advantage of the Nextek system was the 10 to 40 percent efficiency gains that were realized from eliminating the need to convert the solar power from DC to AC, and then back to DC again.

An analysis was conducted in estimating the percentage of the total Summit State Bank building electricity load to determine the approximate sizing of a solar installation that would be necessary for its generation to meet the peak lighting load. A survey of the total number of circuit breakers that served the lighting demand was taken, and the total amperage capacity of these circuit breakers was divided by the total amperage capacity of all circuit breakers. It was estimated that approximately 20 percent of the total building electricity load was used for lighting. This load accounted for approximately 120 percent of the total generation capacity of the building's rooftop real estate for solar. As such, the Nextek system utilized the solar electricity generated for the lighting load exclusively in taking advantage of a 10-40 percent efficiency gain associated with avoiding DC to AC conversion. A risk was introduced, however, if one of the tenants moves out while the solar system is still in use. In this scenario, the lighting load could drop below the generation potential, and the DC electricity could not be utilized.

There were two options for wiring, depending on the intended use of the solar-generated electricity. If the Nextek system was to be used so that the solar-generated electricity was used for lighting, the system should be wired to the Nextek transformer, followed by the lighting control box and switches for individual lighting systems. If the power was be used in applications involving AC electricity, then an inverter will be required to convert the direct current power to AC before connecting to the transformer. Specific wiring considerations, such as type and dimension of wires, parallel versus series connections, and the like were determined by manufacturers and contractors.

The electricity generated by the PV system will be sold to the tenants of the building at a discounted rate relative to the PG&E rate to encourage purchasing. For the financial models, the return on investment (ROI) was calculated based on different discount rates of 5 percent and 10 percent. The building operated on an A-10 rate structure, with rates varying seasonally and with time-of-day.

A solar module selection tool was created that compares the electrical bill savings expected from the Summit State Bank building over an assumed 25 year lifetime of the solar installation to the costs associated with each installation. The tool served as an estimator for selection of the best solar solution so that pricing and performance information of the selected module can be used in a more in-depth cost optimization analysis later. The inputs to the model are as follows:
Santa Rosa average daily insolation—4.48 kWhr/m2/day
Summit State Bank rooftop area available for solar panels—394 m2
Average electricity cost—$0.169/kWhr

The model first calculated the average daily electrical energy generated using the area available, based on the efficiency of various solar panel options. Then, the yearly electricity bill savings associated with an installation using the maximum amount of rooftop space available was calculated. This information was used to determine the net present value of these savings over a 25 year period. The present value of savings was calculated with the following formula:

$$PV = C \frac{1 - {( 1 + i )}^{- n}}{i}$$

Where C is the yearly savings, i is the interest rate, and n is the number of years over which the savings are received. The total cost of the installation was then calculated and a ratio of the net present value of the installation savings to the total costs was used to determine a savings/cost ratio that was used as the metric for optimization.

The following solar module options were used for this analysis:
REC Solar—Model AE205-US
REC Solar—Model AE210-US
REC Solar—Model AE215-US
REC Solar—Model AE220-US
Sharp—Model NC 224UC1
Sharp—Model NU-235F1
Sharp—Model 170W NE170UC1
Sanyo—Model HIT-N220A01
Sanyo—Model HIT-N210A01
Suntech—Model STP260-24/Vb-1
Suntech—Model STP270-24/Vb-1
Suntech—Model STP280-24/Vb-1
Canadian Solar—Model CS6X-295M
Canadian Solar—Model CS6P-235P
Canadian Solar—Model CS6P-230P

The model predicted that the Canadian Solar module, Model Number CS6X-295M will result in the highest savings-to-cost ratio for this project. This module has the following specifications:

| | Nominal | | | | | | | Temperature |
|---|---|---|---|---|---|---|---|---|
| | Power | Module | Area | | | | | Coefficient |
| Cell Type | (W) | Efficiency | (m²) | Vₘₚ | Iₘₚ | V_{oc} | I_{sc} | for Pₘₐₓ |
| Mono- | 295 | 15.4% | 1.92 | 36.4 | 8.11 | 44.9 | 8.63 | −0.45%/° C. |
| crystalline | | | | | | | | |

With the optimal solar module selected, the rooftop area analyzed, and the building loads summarized, enough input information had been gathered to conduct a financial analysis using the System Advisor Model (SAM), developed by NREL. The most useful outputs from the SAM model were the monthly energy generation expected from the solar module and the annual energy output expected after taking into account various efficiency reductions associated with wiring and inverters. As expected, the output of the system during the summer months greatly exceeded generation in the winter months.

After all of the losses, the resulting deliverable output of the system is thus expected to be approximately 80,000 kWhr/year of AC power. This figure includes de-rating of the efficiency of the solar panels over their 25 year lifetime and estimated efficiency reductions associated with wiring and the inverter. It is clear from this analysis that the inverter imparts a significant reduction in system efficiency, motivating the use of the DC power generated at the source made possible by the Nextek system.

Since the customers agreed to purchase a certain amount of power, the business model necessitates a backup system to deliver electricity when the solar panels cannot. It was therefore prudent to consider alternative generation systems that will deliver the guaranteed power regardless of the solar resource availability. A fuel cell is one potential technology that could supplement the solar power on cloudy days. The Bloom Energy power serve fuel cell technology (Model ES-5000) was considered for this purpose because its size is well-suited to be able to supplement the peak power that can be generated from the solar resource available on the Summit State Bank rooftop. The ES-5000 module can provide 100 kW maximum, which compares fairly well with the peak solar power that was generated (60 kW). The ES-5000 module costs between $700,000 and $800,000, which is five times the cost of the Canadian Solar module described earlier. Due to the untenable increase in cost associated with implementing redundancy for cloudy conditions, it was deemed more reasonable to supplement the solar power generated with grid power at this time for the Summit State Bank building.

The peak generation potential of the Canadian Solar module selected with the real estate available was 60.7 kW. Using the insolation data for Santa Rosa, the resulting average solar insolation was 4.48 kWhr/day. The high efficiency of the solar panel specified resulted in a total yearly generation potential of 219 kWhr-AC/day or 80,000 kWhr-AC/year.

The total cost of various solar power generation systems took into account the following expenses:
Module
Inverter
Racking
Electrical Wiring
Monitoring
Shipping
Direct Labor
Engineering and Documentation
Overhead

While the costs of the solar modules were readily available, the remaining costs varied depending on the types of components and services used. Therefore, high and low estimates of the different expenses are shown below in terms of $/W, as provided by REC Solar.

| Item | Low ($/kW) | High ($/kW) |
|---|---|---|
| Inverter | 0.27 | 0.53 |
| Racking | 0.25 | 0.50 |
| Electrical Wiring | 0.28 | 0.45 |
| Monitoring | 0.04 | 0.13 |
| Shipping | 0.04 | 0.05 |
| Direct Labor | 0.40 | 0.56 |
| Engineering & Documentation | 0.35 | 0.42 |
| Overhead | 0.33 | 0.54 |

With these cost estimates, the total per module cost of the solar power generation systems was determined. Of course, some of the costs tabulated above are fairly independent of module efficiency (i.e. racking, direct labor, shipping), making the price-per-watt better serving as a project price estimation tool rather than a decision tool. A low and high estimated cost was determined for each type of module. The Canadian Solar CS6X-295M module had a low total cost of $1,257.20 per module and a high total cost of $1,617.10 per module.

In terms of the Summit State Bank project, a total of 205 modules were required to cover the 394 m² of available rooftop space. This corresponds to a total development cost ranging from $257,726.00 to $331,505.50.

If the Summit State Bank project is conducted together with other projects, it is expected that the development cost will decrease due to volume discounts in the purchasing and installation costs. For the financial analysis, discounts of 0% and 20% on total costs are considered.

Financial calculations projected the return on investment (ROI) and cash-on-cash return for the Summit State Bank solar power generation system. Annual return on investment is defined as:

$$Annual ROI = \frac{Total Cash Inflow - Total Cash Outflow}{Project Development Cost}$$

The cash inflows and outflows for each year were assumed as follows. The cash outflow included interest expenses associated with any debt and insurance costs (assumed to be 0.5% of project cost). Property tax was not included. Also not included in the outflows of this analysis was the annual cost of panel maintenance and cleaning. It was assumed that maintenance and cleaning costs will be borne by the panel providers, and the costs were accordingly included within the initial project cost estimates. Most of the annual cash inflow occurred in the form of revenue generated from sales of solar-generated electricity, which was calculated by average electricity price times expected energy generation. Future advanced analyses should couple expected peak and off-peak pricing and generation, as this should improve expected revenues. The ROI analysis assumed that 100 percent of the energy generated by the PV system was consumed by the building, with none sold back to the utility.

Cash-on-cash return served as a metric for assessment of returns that investors can expect. The cash-on-cash return normalized the net annual cash flow by the actual cash provided by the investor.

$$Annual Cash on Cash Return = \frac{Total Cash Inflow - Total Cash Outflow}{Project Development Cost - Costs Paid for with Loans}$$

If money can be borrowed at a low-enough interest rate, then leverage can increase investor returns. Cash-on-cash returns can be maximized by selecting an optimal debt-to-equity ratio for a given project.

Such an analysis was outside of the scope of this project, so for this analysis, returns were only calculated for cases when 50 percent of the project was paid for with debt and when 0 percent of the project was paid for with debt. A 5 percent interest rate was assumed, which was not unreasonable considering that the solar modules served as collateral.

Return on Investment is calculated for solar panel installation project under various scenarios, including:

| | Best Case | Best Case | | |
|---|---|---|---|---|
| | with Nextek | without Nextek | Probable Case | Bad Case |
| Project Cost | Low; 30% | Low; 30% | Mid; no | High; no |
| | government | government | incentive | incentive |
| | incentive | incentive | | |
| | discount | discount | | |
| Inverter | 100% efficient | 80% efficient | 80% efficient | 80% efficient |
| Inefficiency | Nextek (DC) | DC to AC | DC to AC | DC to AC |
| | | conversion | conversion | conversion |
| “Bulk” Price | 20% discount | 20% discount | 20% discount | 0% discount |
| Discount | | | | |
| Debt | 50% of | 50% of | No loan | No loan |
| | principal | principal | | |
| | 5% interest | 5% interest | | |

As calculated in the Development Costs section, the low estimate of purchasing/installation expenses was $257,726.00. The high estimate was $331,505.50. The probable case averaged these project costs, for a total cost of $294,615.75. In the best case, 30 percent of the project cost was deducted to account for government incentives and tax credits. The volume discount in expenses was assumed to be between 0 and 20 percent. Thus, the lowest possible development cost of the system was $206,180.80. The highest possible development cost was $331,505.50.

Summarizing these assumptions, the best case scenario was defined as low purchasing/installation expenses, use of the Nextek system, 20 percent volume discount on expenses, and a 10 percent discount on electricity rates. The worst case scenario was defined as high purchasing/installation expenses, a 20 percent reduction in system efficiency due to inverter losses, 0 percent volume discount on expenses, and 10 percent discount on electricity rates. An analysis was also conducted that compares the effect of the discount on electricity rate, using the best case scenario, and 5 percent and 10 percent discount rates for comparison.

The best case scenario was projected to generate a cash-on-cash return of 13.5 percent in year one, increasing to 18.56 percent by year ten. The worst case scenario was projected to generate a cash-on-cash return of 3.1 percent in year one, increasing to 3.86 percent in year ten. Annual increases in revenues were due to a projected 3.57 percent increase in utility electricity prices, which was slightly less than the United States average annual increase in commercial electricity rates from 1993 to 2004 of 3.8 percent per year.

Future analyses including the fact that more electricity will be generated during peak pricing rate times could improve calculated returns.

It was also instructive to investigate the effect of varying the pricing discount at which electricity is sold to the consumer as compared to the PG&E rate. The electricity price was assumed to be between 5 and 10 percent lower than the average price that PG&E charged the building ($0.169/kWh). Thus, the rate charged the customers was between a high of $0.161/kWh and a low of $0.152/kWh.

It was found, that under certain conditions, the project resulted in favorable returns for investors. When electricity price discounts to the customer were high and cost reductions associated with scale up were low, the expected cash-on-cash return on investment was as low as 3.1 percent in the first year. It was therefore prudent to take advantage of key cost reductions in volume purchasing and to limit the discount rate offered to the consumer in increasing the return on investment. With careful implementation, government and volume discounts, and direct use of DC electricity, the annual cash-on-cash return was as high as 14.6 percent in the first year. A probable case, with no government subsidies, AC power use (inverter losses included), volume pricing discounts, mid-range balance-of-system costs, and a 10 percent electricity price discount relative to utilities returned 5.28 percent to the investors in year one, with returns increasing to 6.65 percent by year ten.

The primary output of the feasibility study was a list of recommendations that will serve to improve the profitability of the business. First, the solar module that optimizes the ratio of electricity bill savings to total costs was Canadian Solar Module CS6X-295M. The relatively high efficiency of the module increased the total energy savings in an amount that balanced its increased costs enough make it a more economical choice than other modules considered. Second, the Nextek Power Management System should be considered as a possible means of increasing total system efficiency by eliminating the efficiency reductions associated with converting the DC power generated by the solar panels to the AC network that the building uses. The main DC power loads in the building were lighting, however, and lighting loads may not always exceed solar electricity generation, especially on weekends or if a tenant moves out. A future analysis should weigh the risks and benefits of using the Nextek DC electricity generation system. Third, the price of electricity delivered to the customer should be negotiated to a minimum discount relative to utility prices so that cash inflows are maximized and returns are improved. Fourth, solar photovoltaic development projects should be conducted in parallel with other projects that use the same module type so as to take advantage of cost reductions associated with bulk purchasing of solar modules.

1. A method for converting underutilized real property into energy producing property, comprising:
bifurcating energy production and management rights of the underutilized real property from existing land and improvements.

2. The method of claim 1, further comprising analyzing the existing land and improvements to ascertain the underutilized real property to be bifurcated.

3. The method of claim 2, further comprising analyzing the bifurcated underutilized real property to determine a portion to be initially converted to the energy producing property.

4. (canceled)

5. (canceled)

6. The method of claim 3, wherein the energy production and management rights grant a third party a right to install, operate, or manage energy producing equipment on the portion of the bifurcated property initially converted to the energy producing property.

7. The method of claim 6, wherein the energy producing equipment comprises energy storage devices.

8. The method of claim 1, wherein the energy production and management rights grant a third party ingress and egress rights to the bifurcated underutilized real property.

9. (canceled)

10. The method of claim 1, wherein the energy production and management rights include generating electricity using solar radiation.

11. The method of claim 1, wherein the energy production and management rights include generating electricity using biodiesel combustion.

12. The method of claim 1, wherein the energy production and management rights include generating electricity using natural gas combustion.

13. The method of claim 1, wherein the energy production and management rights include generating electricity using a fuel cell.

14. The method of claim 1, wherein the energy production and management rights include generating electricity using a windmill.

15. The method of claim 1, wherein the energy production and management rights include generating electricity using a wind turbine.

16. The method of claim 1, wherein the energy production and management rights include generating electricity using an anaerobic digester system.

17. (canceled)

18. The method of claim 1, wherein the bifurcated underutilized real property comprises multiple non-contiguous areas of underutilized real property.

19. (canceled)

20. (canceled)

21. The method of claim 6, wherein the energy producing equipment is comprised of solar panels.

22. (canceled)

23. (canceled)

24. (canceled)

25. (canceled)

26. (canceled)

27. (canceled)

28. (canceled)

29. (canceled)

30. (canceled)

31. (canceled)

32. The method of claim 6, further comprising providing access to energy produced by the energy producing equipment to a second existing land and improvements or an electric grid.

33. (canceled)

34. The method of claim 32, further comprising bifurcating the energy production and management rights of an underutilized real property from the second existing land and improvements.

35. (canceled)

36. (canceled)

37. The method of claim 1, further comprising:
analyzing the existing land and improvements to ascertain the underutilized real property to be bifurcated;
analyzing the bifurcated underutilized real property to determine a portion to be initially converted to the energy producing property;
developing an energy purchase agreement between a third party and an owner of the existing land and improvements; and
installing energy producing equipment on the portion of the bifurcated underutilized real property and providing access to energy produced by the energy producing equipment to a second existing land and improvements or an electric grid.

38. (canceled)

39. A method for converting underutilized real property into energy producing property, comprising:
analyzing the existing land and improvements to ascertain the underutilized real property to be bifurcated;
analyzing the bifurcated underutilized real property to determine a portion to be initially converted to the energy producing property;
developing an energy purchase agreement between a third party and an owner of the existing land and improvements; and
bifurcating energy production and management rights of the underutilized real property from existing land and improvements.

40. A method for converting underutilized real property into energy producing property, comprising:
analyzing the existing land and improvements to ascertain the underutilized real property to be bifurcated;
analyzing the bifurcated underutilized real property to determine a portion to be initially converted to the energy producing property;
developing an energy purchase agreement between a third party and an owner of the existing land and improvements;
bifurcating energy production and management rights of the underutilized real property from existing land and improvements; and
installing energy producing equipment on the portion of the bifurcated property initially converted to the energy producing property.
